(19) United States
(12) Patent Application Publication
(10) Pub. No.: US 2007/0105008 A1
(43) Pub. Date: May 10, 2007

(54) Thin film fuel cell assembly

(75) Inventors: Zhijun Gu, Shanghai (CN); Derong Wu, Shanghai (CN)

Correspondence Address: WILMER CUTLER PICKERING HALE AND DORR LLP, 60 STATE STREET, BOSTON, MA, 02109, US

(73) Assignee: Horizon Fuel Cell Technologies Pte. Ltd, Singapore (SG)

(21) Appl. No.: 11/586,352

(22) Filed: Oct. 25, 2006

Related U.S. Application Data
(60) Provisional application No. 60/729,951, filed on Oct. 25, 2005.

(51) Int. Cl. H01M 4/94; H01M 4/96

(52) U.S. Cl. 429/44; 429/42

(57) ABSTRACT

A fuel cell assembly including: a membrane electrode assembly and current collector sub-unit including (i) a polymer electrolyte membrane having a cathode side and an anode side; (ii) catalyst layers disposed, respectively, on both sides of the polymer electrolyte membrane; (iii) gas diffusion layers disposed, respectively, on sides of both catalyst layers, wherein the gas diffusion layers are laminated on the catalyst layers; and (iv) porous current collectors disposed, respectively, on sides of both gas diffusion layers, wherein the porous current collectors are laminated on the gas diffusion layers. The fuel cell assembly also includes a hydrogen supplier layer disposed on the anode side of the sub-unit, sealed to the edges of the sub-unit and forming an anode chamber; and a hydrogen inlet and a hydrogen outlet connected the anode chamber.

This application claims the benefit of U.S. Provisional Application No. 60/729,951, filed Oct. 25, 2005, the contents of which are incorporated herein by reference.

### TECHNICAL FIELD

This invention relates to fuel cell assemblies.

### BACKGROUND OF THE INVENTION

Proton exchange membrane (PEM) fuel cells are electrochemical devices that convert chemical energy of hydrogen into electrical energy without combustion. They have high potential to offer an environmentally friendly, high-energy density, efficient, and renewable power source for various applications from portable devices to vehicles and stationary power plants.

PEM fuel cells operate at relatively low temperatures, have higher power density than direct methanol fuel cells, and can quickly respond to changes in power demand. For portable power applications, PEM fuel cells might be light weight and compact size to compete with conventional batteries, and various arts have been developed and are being developed to address the weight and size issue of PEM fuel cells.

A basic single PEM fuel cell unit (FIG. 1) includes a proton exchange membrane 1, an anode catalyst layer 3, a cathode catalyst layer 2, an anode gas diffusion layer 5, a cathode gas diffusion layer 4, an anode current collector 7, a cathode current collector 6, and cathode air channels 8 and anode fuel channels 9. Cooling channels, separator plates, end plates, sealing gaskets, etc. can be added to the fuel cell depending on configurations. The operation of a PEM fuel cell includes the supply of hydrogen fuel and an oxidizing gas to the anode catalyst layer and cathode catalyst layer, respectively. An electrochemical reaction takes place in the fuel cell, forming water on the cathode side, releasing thermal energy and generating electricity, which is collected by current collectors to drive a load.

In some conventional designs, multiple fuel cell units are stacked together to form a fuel cell stack. One major shortcoming of such conventional fuel cell assemblies is contact resistance between layers of material in the fuel cell and layers of different fuel cells, which causes power loss and internal heat generation. The layers must be held in intimate electrical contract with each other to reduce the fuel cell's internal resistance. One conventional design to reduce contact resistance is to clam the single fuel cell or a fuel cell stack through the use of end plates, bolts and screws. Considerable compression force is needed to achieve minimum contact resistance, requiring the end plates to have high structure strength. End plates are often made of metals such as aluminum or ePoxy fiber composites. This is an effective approach to reduce contact resistance, however it adds significant complexity, weight and size to the fuel cell, making it not suitable for portable applications where light weight and compact size are required.

One additional problem found in conventional fuel cell assemblies is that reactant gas flow channels need to be machined, etched or molded on the plates. The gas flow channels create sealing problems and add weight, size and cost to the fuel cell. It is advantageous if the flow channels could be replaced.

Some prior art systems introduced micro fabrication techniques for compact fuel cell designs. U.S. Pat. No. 6,864,010 introduced a fuel cell of which a porous substrate is filled with electrolyte and catalyst and current collector layers are deposited through a thin film coating approach, such as sputtering, electroless plating, electroplating, soldering, physical vapor deposition, chemical vapor deposition, etc. U.S. Pat. No. 5,631,099 disclosed a planar fuel cell design which uses thin film coating technology to coat catalyst layer to a composite membrane and coats the current collector layer to the catalyst layer or gas diffusion layer. Compared to conventional technologies, those prior art systems do have improvements in the area of fuel cell power density, especially for fuel cells less than 10 watts, however, those thin film coating technologies are still very complicated and costly, not suitable for mass producing low cost fuel cells.

For a fuel cell to compete with conventional batteries, it must not only have the desired performance and cost, but also be capable of being mass-produced. Lamination is a preferred method for fuel cell assembly and it would enable a roll-to-roll manufacturing process for fuel cells, which is a mass manufacturing technique widely applied within many industries. It is also important to design the fuel cell as simply as possible to reduce unnecessary parts and components, as well as to improve its reliability.

### SUMMARY OF THE INVENTION

One objective of certain embodiments of the invention is to reduce the fuel cell's contact resistance between layers without clamping the fuel cell or applying thin film deposition technology, so that a very light weight and very compact size fuel cell can be manufactured.

A second objective of certain embodiments of the invention is to reduce the amount of fuel cell components and parts through innovative designs, thus further reducing the weight and size of fuel cells, improving product reliability, and minimizing material and production costs.

A third objective of certain embodiments of the invention is to provide a fuel cell design which can adopt a simple lamination process for fuel assembly, eventually enabling roll-to-roll manufacturing of fuel cells.

To achieve at least some of the above objectives, a highly conductive and high polymer content gas diffusion material is used in the fuel cell assembly to replace the conventional carbon fiber paper or carbon fiber cloth. Porous current collectors are used to replace conventional graphite plates or metal plates, and a thin gas supply material is used to replace conventional reactant gases flow channels.

A membrane electrode assembly and current collector sub-unit can be made in a one step or multi-step lamination process by placing a catalyst coated membrane between two highly conductive and high polymer content gas diffusion layers, and placing two porous current collectors on the outer sides of both gas diffusion layers. A hydrogen supply layer can be further laminated to the sub-unit to form a fuel cell assembly.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a conventional fuel cell unit.

FIG. 2 is a membrane electrode assembly and current collector sub-unit.

FIG. 3 is a single fuel cell unit.

FIG. 4 is a double cell unit.

FIG. 5 is a block diagram of a system that incorporates the laminated fuel cell structure described herein.

### DETAILED DESCRIPTION

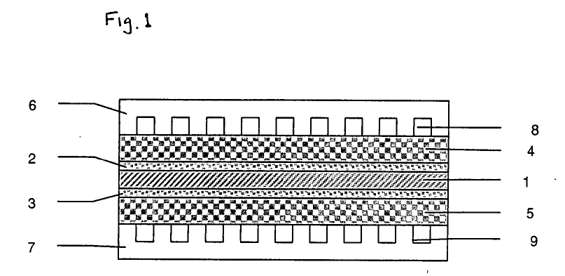

A conventional fuel cell (FIG. 1) has at least a proton exchange membrane 1 in the center, catalyst layers 2, 3 on both sides of the membrane 1, gas diffusion layers 4, 5 on sides of the catalyst layers 2, 3, fuel channels 8, 9 and current collectors 6, 7, on sides of both of the gas diffusion layers 4, 5. Microporous layers, end plates, bolts and screwing, cooling plates may also be added to a fuel cell depending on configurations. Commercial membrane electrode assembly is available from various suppliers such as W.L. Gore and DuPont. A typical 3 layer MEA is called catalyst coated membrane (CCM), with catalyst layers 2, 3 coated on both sides of the membrane 1. Alternatively, a catalyst can be coated to gas diffusion layers or to a micro-porous layers (which is applied to the gas diffusion layers) first, then the gas diffusion layers are laminated to the membrane. The gas diffusion layers are usually composed with carbon fiber cloth from Etek (US) etc., or carbon fiber paper material from Toray (Japan), SGL (Germany), etc. The micro-porous layer usually contain less than 15% PTFE solid and more than 85% of carbon material, such as carbon black, Valcon-72 from Cobat, US. Fuel channels, endplates as well as bolts and screws fastening the fuel cell, typically account for 60%-90% of the weight and the size of the fuel cell. The weight and size of a fuel cell can be significantly reduced if end plates, bolts and screws, and fuel channels can be eliminated or simplified. However, without compression force applied by the end plates, in conventional fuel cells, contact resistance between layers will greatly increase and the fuel cell efficiency will significantly decrease.

Various embodiments of the invention use highly conductive and high-polymer content gas diffusion layer to replace the low or no-polymer content gas diffusion layers such as carbon fiber paper, carbon fiber cloth, carbon fiber paper coated with a micro-porous layer, or carbon fiber cloth coated with a micro-porous layer. Under pressure and heat, the polymer inside the highly conductive and high polymer content gas diffusion layer will melt and deform so good adhesions of the gas diffusion layer to the porous current collectors 10,11 such as thin metal film and to the catalyst layers and to the membrane can be achieved. Contact resistances between layers can be greatly reduced and a high efficiency, high power density fuel cell can be made as a result.

The highly conductive and high polymer content gas diffusion layers are made of polymers selected from thermal plastics materials such as PTFE, PVDF, ETFE, PP, PE etc., and conductive materials selected from carbon black, graphite power, soot, carbon fiber, gold, platinum, ruthenium, and any combinations, etc. A preferred polymer is PTFE and a preferred conductive material is carbon black. Carbon fiber can be added to increase the in plane conductivity. The highly conductive and high polymer content material contains 15%-80% of polymer and 20%-85% of conductive materials. Conductivity decreases when the polymer content in the gas diffusion layers increases, and the preferred polymer weight percentage is from 25% to 70%. The conductivity of the layer is typically less than 20 mohoms-cm² or preferably less than 10 mohoms-cm². The highly conductive and high polymer content gas diffusion layers are commercially available from suppliers such as Taiqiao Electronics in China.

The current collectors need to be porous to allow reactant gases to diffuse. Porous metal mesh, carbon fiber paper, carbon fiber cloth and graphite film are suitable. The material should have high in plane conductivity and good corrosion resistance. Metal materials such as titanium, nickel, stainless steel, gold, platinum, ruthenium, etc. can be used and titanium, nickel and stainless steel, are preferred due to their conductivity and anti-corrosion capability. The titanium mesh, nickel mesh and stainless stain mesh can be further anti-corrosion treated. Thin TiN, CrN, Au, Ru, RuO and graphite film can be formed on the surfaces on the metal meshes. Surface treatment techniques are well-know in the industry and thus are not discussed in detail here.

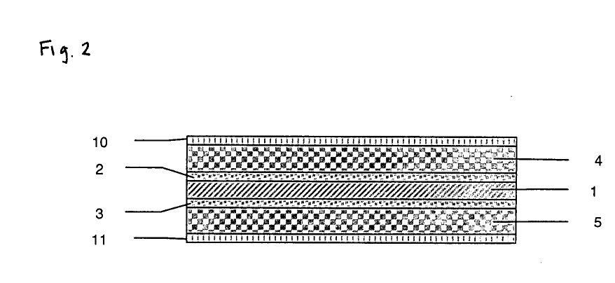

To make a membrane electrode assembly and current collector sub-unit FIG. 2, the highly conductive and high polymer content gas diffusion layers 4, 5 are laminated to porous current collectors 10, 11 first, and then catalyst layers 2, 3 are coated to the outer side of the gas diffusion layers 4, 5. The above materials can be cut into single cell shape and laminated to both sides of a proton exchange membrane 1 in one step. This approach is beneficial to manufacture multiple single cells on one sheet of membrane, especially for a fuel cell systems containing multiple single cells connected in series or in parallel, and for roll-to-roll manufacturing of fuel cells.

Alternatively, the highly conductive and high polymer content gas diffusion layers 4, 5 are laminated to the porous current collectors 10, 11 first, and then a catalyst coated membrane 1, 2, 3 is sandwiched between the two gas diffusion layers 4, 5 and laminated. Alternatively, the above multi layers of materials can be laminated in a single step process or in a multiple step process.

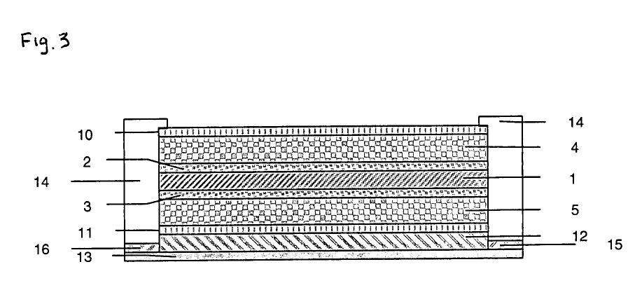

Referring to FIG. 3, a hydrogen supply layer has a porous layer 12 and a non-porous layer 13. The porous layer 12 allows hydrogen gas to diffuse inside the fuel cell and the non-porous side seals the anode chamber. The porous layer 12 is a flexible porous fiber material, such as a porous PE fiber mat, non-woven glass fiber mat, etc. The non-porous layer 13 can be selected from plastic films, metal films, graphite films, etc. A plastics film with a melting temperature of over 110° C. is preferred. The porous layer 12 and the non-porous layer 13 can be laminated together first then sealed to the edges of the anode side of the sub-unit by glue or lamination. Alternatively, the hydrogen supply layer has only a non-porous layer 13, and sealed to the edges of the anode side of the sub-unit by glue or lamination. Hydrogen gas will diffuse through the gaps between the non-porous layer 13 and the anode current collector. In addition, flow channels can be etched or machined on the non-porous layer 13.

The membrane electrode assembly and current collect sub unit can be hold in a thin frame 14. The edges of the sub-unit are embedded in the frame 14 and sealed gas tight. The hydrogen supply layer is glued or laminated to the frame forming a hydrogen chamber. Alternatively, the hydrogen supply layer can be glued or laminated directly to the edges of the anode side of the sub-unit. The preferred glue is a silicon rubber adhesive.

A hydrogen inlet 15 and a hydrogen outlet 16 are installed to the hydrogen chamber formed by the non-porous layer 13 and the edges of the sub-unit.

### EXAMPLE 1

A 5 cm×5 cm highly conductive and high polymer content gas diffusion layer is laminated to a 5 cm×5 cm titanium film (porous current collector) under pressure of 200 B and temperature of 160° C. for 1 minute. A catalyst ink with a Pt loading of 0.4 mg/cm2 is coated to the gas diffusion layer. The laminated and catalyst coated material is cut into four pieces, each with a size of 2.5 cm×2.5 cm. A 5.5 cm×2.5 cm proton exchange membrane is placed in between the two pieces and laminated at below 200 Bar and at a temperature of 160 C for 2 minutes. A membrane electrode assembly and current collector sub-unit with two cells is produced.

The sub-unit is placed in two pieces of plastics frame and laminated. Then a non-porous plastic film is further laminated to the anode side of the sub-unit and a hydrogen inlet needle and a hydrogen outlet needle are installed on the fuel cell unit.

After supplying hydrogen to the fuel cell and connecting it to a load, a voltage of 1.4V and current of 0.15 A are observed.

### EXAMPLE 2

A 2.5 cm×2.5 cm CCM is sandwiched between two 2.5 cm×2.5 cm highly conductive and high polymer content gas diffusion layers, and two 2.5 cm×2.5 cm titanium film (porous current collector) are disposed on the outer sides of both gas diffusion layers. The entire five layers are laminated under a pressure of 200 Bar and at a temperature of 160° C. for 2 minutes, to form a membrane electrode assembly and current collector sub-unit.

The sub-unit is placed in two pieces of plastics frame and laminated. Then a non-porous plastics film is further laminated to the anode side of the sub-unit and a hydrogen inlet needle and a hydrogen outlet needle are installed on the fuel cell unit.

After supplying hydrogen to the fuel cell and connecting it to a load, a voltage of 0.7 and current of 0.15 A are observed.

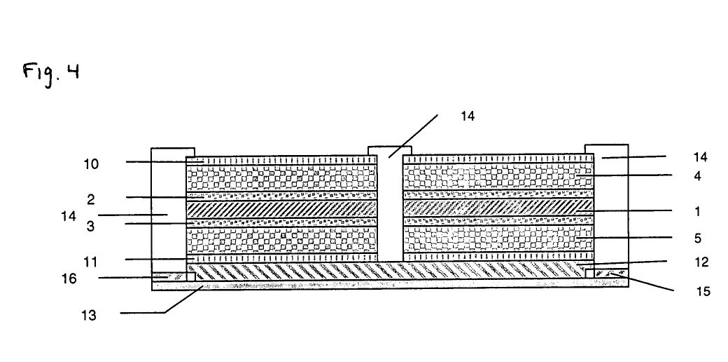

FIG. 4 shows double cell unit. It includes membrane 1, catalyst layers 2, 3 on both sides of the membrane, gas diffusion layers 4, 5 on sides of both catalyst layers, a porous cathode current collector 10, a porous anode current collector 11, a porous layer 12 for hydrogen gas supply, a non-porous layer 13 sealed to edges of the frame 14 of the sub-unit, hydrogen inlet 15 and hydrogen outlet 16 are installed to the frame. The two single cells share the porous layer 12 and the non-porous layer 13.

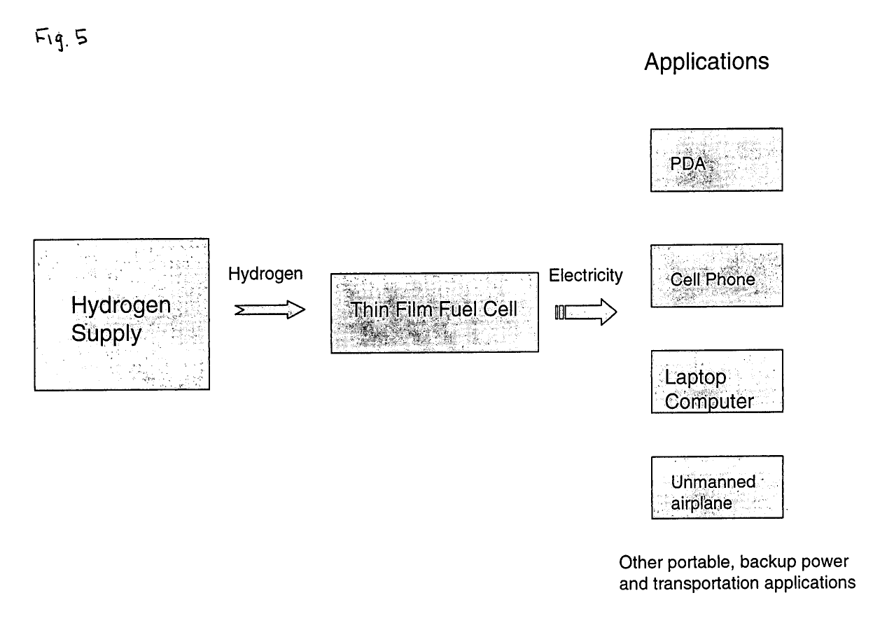

FIG. 5 is a block diagram of a system in which the above-described thin film fuel cell can be incorporated. Generally, the system also includes a hydrogen supply as well as the hardware that is being powered by the fuel cell, e.g. a PDA, a cell phone, a laptop computer or even the control systems in an unmanned airplane, just to name a few of many examples.

Other embodiments are within the following claims.

What is claimed is:

1. A fuel cell assembly comprising:
a) a membrane electrode assembly and current collector sub-unit including
i. a polymer electrolyte membrane having a cathode side and an anode side;
ii. catalyst layers disposed, respectively, on both sides of the polymer electrolyte membrane;
iii. gas diffusion layers disposed, respectively, on sides of both catalyst layers, wherein the gas diffusion layers are laminated on the catalyst layers; and
iv. porous current collectors disposed, respectively, on sides of both gas diffusion layers, wherein the porous current collectors are laminated on the gas diffusion layers
b) a hydrogen supplier layer disposed on the anode side of the sub-unit, sealed to the edges of the sub-unit and forming an anode chamber; and
c) a hydrogen inlet and a hydrogen outlet connected the anode chamber.

2. The fuel cell assembly of claim 1, wherein the gas diffusion layers have a 15%-80% weight percentage of polymers and a 20%-85% weight percentage of conductive materials.

3. The gas diffusion layers of claim 2, wherein the polymer contains at least one polymer selected from the group consisting of PVDF, PTFE, ETFE, PE, and PP.

4. The gas diffusion layer of claim 2, wherein the conductive materials contain at least one material selected from the group consisting of carbon black, soot, graphite powder, carbon fiber, gold and platinum.

5. The fuel cell assembly of claim 1, wherein the porous current collectors are highly conductive porous materials, selected from the group consisting of metal mesh, carbon fiber cloth, carbon fiber paper and graphite film.

6. The porous current collectors of claim 5, wherein the metal mesh is selected from the group consisting of stainless steel mesh, nickel mesh, and titanium mesh.

7. The porous current collectors of claim 5, wherein the metal mesh is surface treated with at least one anti-corrosion layer selected from the group consisting of TiN, CrN, RuO, gold, Ruthenium, graphite or any combinations.

8. The fuel cell assembly of claim 1, wherein the hydrogen supply layer has a porous diffusion layer on the inner side, and a non-porous gas tight layer on the outer side, wherein the porous diffusion layer is a fiber material and the non-porous gas tight layer is selected from the group consisting of a plastic film, metal film and graphite film.

9. The fuel cell assembly of claim 1, wherein the hydrogen supplier layer is a non-porous gas tight material selected from the group consisting of a plastic film, metal film, and graphite film.

10. The fuel cell assembly of claim 1, wherein the sub-unit has a sealing frame and the hydrogen supply layer is sealed to the frame by lamination or glue.

11. The fuel cell assembly of claim 1, wherein the hydrogen supply layer is sealed to the edges of the porous current collectors by lamination or glue.

12. A fuel cell system comprising:
a) a plurality of membrane electrode and current collector sub-units, each of the sub units including:
i. a polymer electrolyte membrane having a cathode side and an anode side;
ii. catalyst layers disposed, respectively, on both sides of the polymer electrolyte membrane;
iii. gas diffusion layers disposed, respectively, on sides of both catalyst layers, wherein the gas diffusion layers are laminated on the catalyst layers; and
iv. porous current collectors disposed, respectively, on sides of both gas diffusion layers, wherein the porous current collectors are laminated on the gas diffusion layers;
b) at least one hydrogen supplier layer disposed on the anode side of the sub-units, sealed to the edges of the sub-units and forming at least one anode chamber; and
c) at least one hydrogen inlet and at least one hydrogen outlet connected at least one anode chamber, wherein the porous current collectors of the sub-units are connected either in series or in parallel.
